(19) United States
(12) Patent Application Publication
(10) Pub. No.: US 2023/0390869 A1
(43) Pub. Date: Dec. 7, 2023

(54) ADDITIVE MANUFACTURED OBJECT AND METHOD OF MANUFACTURING ADDITIVE MANUFACTURED OBJECT

(71) Applicant: Mitsubishi Electric Corporation, Tokyo (JP)

(72) Inventors: Takafumi FUJII, Tokyo (JP); Satoshi HATTORI, Tokyo (JP); Nobuyuki SUMI, Tokyo (JP)

(73) Assignee: Mitsubishi Electric Corporation, Tokyo (JP)

(21) Appl. No.: 18/033,817

(22) PCT Filed: Mar. 19, 2021
(86) PCT No.: PCT/JP2021/011507

§ 371 Date: Apr. 26, 2023

(51) Int. Cl. B23K 26/342; B32B 15/01; B33Y 10/00; B33Y 80/00; B22F 10/28

(52) U.S. Cl. CPC B23K 26/342; B32B 15/01; B33Y 10/00; B33Y 80/00; B22F 10/28

(57) ABSTRACT

An additive manufactured object is a stack including a first metal layer made of a first metallic material and a second metal layer that includes second dot beads made of a second metallic material. The additive manufactured object includes an intermediate layer between the first and second metal layers. The intermediate layer includes a first structural part as a structure made of the first metallic material and a second structural part as a structure made of the second metallic material. The first and second structural parts engage each other in a unit structure, and an arrangement of the unit structures arranged in the intermediate layer has translational symmetry in a plane perpendicular to a stacked direction of the first and second metal layers. The intermediate layer includes, at a junction interface between the first and the second structural parts, an intermetallic compound layer including an intermetallic compound.

### FIELD

The present disclosure relates to an additive manufactured object made with different kinds of metallic materials by additive manufacturing. The present disclosure also relates to a method of manufacturing the additive manufactured object and an additive manufacturing apparatus.

### BACKGROUND

An additive manufacturing method using a three-dimensional object manufacturing technique called additive manufacturing (AM) has been known for stacking different kinds of metal into an additive manufactured object that is a three-dimensional object. In the additive manufacturing method, a molten pool is generally formed on a first metal layer made of a first metal with a laser or an energy beam such as an electron beam. A second metal different from the first metal is fed in the form of a wire to the molten pool, melted, and then solidified to form a second metal layer. As a result, an additive manufactured object is obtained. However, depending on the combination of the first metal and the second metal, a brittle intermetallic compound may be formed at a junction interface between the first metal layer and the second metal layer, resulting in reduced bond strength at the junction interface.

In an additive manufacturing method disclosed in Patent Literature 1, with phase diagrams as reference, a first metal and a second metal that do not form an intermetallic compound but form a solid solution are preselected as a combination, and an additive manufactured object is formed. Moreover, in the additive manufacturing method described in Patent Literature 1, coupling parts are formed at three or more positions that are not on the same straight line at an interface between a first metal layer made of the first metal and a second metal layer made of the second metal for mechanically coupling the first metal layer and second metal layer. Each of the coupling parts includes a first constituent part that has a T-shaped section including a stacked direction and is made of the first metal and a second constituent part that covers the first constituent part and is made of the second metal.

### CITATION LIST

### Patent Literature

Patent Literature 1: Japanese Patent Application Laid-open No. 2020-41201

### SUMMARY

### Technical Problems

However, in the technique of Patent Literature 1 that preselects the combination that forms the solid solution at the interface between the first metal and the second metal, the selection can only be made for binary combinations. Moreover, the combination that forms the solid solution is in fact limited to pure metals. Pure metals are rarely targeted as a combination of practical metals that is widely used, and a binary alloy or a greater alloy is usual in practical use. Therefore, poor versatility is a problem with the technique described in Patent Literature 1. In addition, since the coupling parts are provided at the at least three positions that are not on the same straight line at the interface between the first and second metal layers, that is to say, on the first metal layer in the technique described in Patent Literature 1, stress concentrates at the coupling parts when force acts in a direction that separates the first and second metal layers. Therefore, another problem is that uniform bond strength cannot be ensured throughout the interface between the first and second metal layers.

The present disclosure has been made in view of the above, and an object of the present disclosure is to obtain an additive manufactured object that ensures uniform bond strength at an interface between a first metal layer and a second metal layer without being limited in terms of a combination of a first metal for the first metal layer and a second metal for the second metal layer as compared with a conventional one.

### Solution to Problems

In order to solve the above-stated problems and achieve the object, an additive manufactured object according to the present disclosure is a stack including a first metal layer made of a first metallic material and a second metal layer that includes second dot beads made of a second metallic material. The additive manufactured object includes an intermediate layer between the first metal layer and the second metal layer. The intermediate layer includes a first structural part as a structure made of the first metallic material and a second structural part as a structure made of the second metallic material. The first structural part and the second structural part engage each other in each of unit structures, and an arrangement of the unit structures arranged in the intermediate layer has translational symmetry in a plane perpendicular to a stacked direction of the first metal layer and the second metal layer. The intermediate layer includes, at a junction interface between the first structural part and the second structural part, an intermetallic compound layer including an intermetallic compound.

### Advantageous Effects of Invention

The additive manufactured object according to the present disclosure has effects of not being limited in terms of a combination of a first metal for the first metal layer and a second metal for the second metal layer as compared with a conventional one and ensuring uniform bond strength at an interface between the first metal layer and the second metal layer.

### BRIEF DESCRIPTION OF DRAWINGS

FIG. 1 is a diagram schematically illustrating an exemplary configuration of an additive manufacturing apparatus according to a first embodiment.

FIG. 2 is a block diagram illustrating a first example of a hardware configuration for a control unit of the additive manufacturing apparatus according to the first embodiment.

FIG. 3 is a block diagram illustrating a second example of the hardware configuration for the control unit of the additive manufacturing apparatus according to the first embodiment.

FIG. 4 is an enlarged view schematically illustrating an example of an object formed by line beads.

FIG. 5 is an enlarged view schematically illustrating an example of an object formed by dot beads.

FIG. 6 is a sectional view illustrating an exemplary configuration of an additive manufactured object according to the first embodiment.

FIG. 7 is a perspective partial view illustrating the exemplary configuration of the additive manufactured object according to the first embodiment.

FIG. 8 is a partial sectional view illustrating the exemplary configuration of the additive manufactured object according to the first embodiment.

FIG. 9 is a diagram illustrating an exemplary configuration of an intermediate layer of the additive manufactured object according to the first embodiment.

FIG. 10 is a diagram illustrating another exemplary configuration for the intermediate layer of the additive manufactured object according to the first embodiment.

FIG. 11 is a diagram schematically illustrating an example of a junction interface between a first dot bead and a second dot bead in the additive manufactured object according to the first embodiment.

FIG. 12 is a diagram illustrating an example of a state of components at the junction interface between the first dot bead and the second dot bead in the additive manufactured object according to the first embodiment.

FIG. 13 is a phase diagram of Al—Fe.

FIG. 14 is a sectional view schematically illustrating a procedural example of a method of manufacturing the additive manufactured object according to the first embodiment.

FIG. 15 is a sectional view schematically illustrating the procedural example of the method of manufacturing the additive manufactured object according to the first embodiment.

FIG. 16 is a sectional view schematically illustrating the procedural example of the method of manufacturing the additive manufactured object according to the first embodiment.

FIG. 17 is a sectional view schematically illustrating the procedural example of the method of manufacturing the additive manufactured object according to the first embodiment.

FIG. 18 is a sectional view schematically illustrating the procedural example of the method of manufacturing the additive manufactured object according to the first embodiment.

FIG. 19 is a diagram schematically illustrating an example of a junction interface between a first dot bead and a second dot bead in a prior art additive manufactured object.

FIG. 20 is a diagram illustrating an example of a state of components at the junction interface between the first dot bead and the second dot bead according to a prior art.

FIG. 21 is a partial sectional view illustrating an exemplary configuration of an additive manufactured object according to a second embodiment.

FIG. 22 is a diagram illustrating an example of how dot beads are arranged in an additive manufactured object according to a third embodiment.

FIG. 23 is a sectional view illustrating an exemplary configuration of an additive manufactured object according to a fourth embodiment.

FIG. 24 is a perspective view schematically illustrating a procedural example of a method of manufacturing the additive manufactured object according to the fourth embodiment.

FIG. 25 is a perspective view schematically illustrating the procedural example of the method of manufacturing the additive manufactured object according to the fourth embodiment.

FIG. 26 is a perspective view schematically illustrating the procedural example of the method of manufacturing the additive manufactured object according to the fourth embodiment.

FIG. 27 is a perspective view schematically illustrating the procedural example of the method of manufacturing the additive manufactured object according to the fourth embodiment.

FIG. 28 is a perspective view schematically illustrating the procedural example of the method of manufacturing the additive manufactured object according to the fourth embodiment.

FIG. 29 is a perspective view schematically illustrating the procedural example of the method of manufacturing the additive manufactured object according to the fourth embodiment.

FIG. 30 is a perspective view schematically illustrating the procedural example of the method of manufacturing the additive manufactured object according to the fourth embodiment.

### DESCRIPTION OF EMBODIMENTS

With reference to the drawings, a detailed description is hereinafter provided of additive manufactured objects, methods of manufacturing the additive manufactured objects, and an additive manufacturing apparatus according to embodiments of the present disclosure.

### First Embodiment

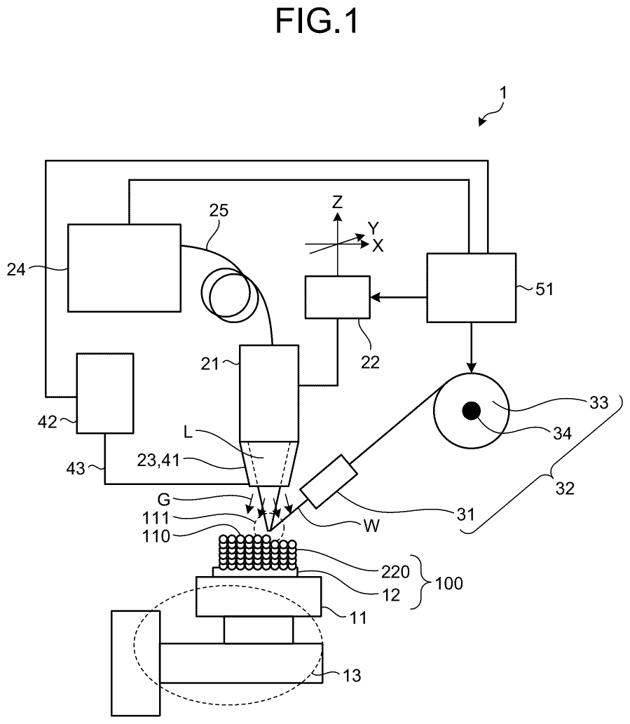

FIG. 1 is a diagram schematically illustrating an exemplary configuration of an additive manufacturing apparatus according to a first embodiment. An additive manufacturing apparatus 1 is a directed energy deposition (DED) additive manufacturing apparatus that produces an additive manufactured object 220 that is a three-dimensional object by repeating an additive process of adding a material melted by beam irradiation to a target additive face 110 of a workpiece 100. An X-axis and a Y-axis are two axes orthogonal to each other in a plane face of a base member 12 that is where the additive manufactured object 220 is formed with the base member 12 placed on a stage 11. A Z-axis is an axis perpendicular to both the X- and Y-axes.

The additive manufacturing apparatus 1 includes the stage 11 on which the workpiece 100 is placed and a stage actuator not illustrated. The workpiece 100 includes the base member 12 and the additive manufactured object 220 that is built on the base member 12. The base member 12 is placed on the stage 11. Beads are added to a face of the workpiece 100 that is referred to as the target additive face 110. The base member 12 illustrated in FIG. 1 is plate-shaped. Instead of being plate-shaped, the base member 12 may have another shape.

The additive manufacturing apparatus 1 includes a machining head 21 that irradiates a machining point 111 with a laser beam L and melts a wire W as a process material and a head actuator 22 that moves the machining head 21. The machining head 21 includes a beam nozzle 23 that irradiates the machining point 111 with the laser beam L, two or more wire nozzles 31 that each feed the wire W to the machining point 111, and a gas nozzle 41 that ejects a shielding gas G toward the machining point 111. The machining point 111 is an irradiation position for the laser beam L on the target additive face 110 and is an area to which the process material is added. The machining point 111 is shifted along a machining path while the additive process is carried out.

The beam nozzle 23 emits the laser beam L, a heat source that melts the process material, toward the machining point 111 on the workpiece 100. The energy source that melts the process material may be an electron beam, an arc discharge, or another energy source instead of the laser beam L. Each wire nozzle 31 advances the wire W toward the irradiation position for the laser beam L that is on the workpiece 100. In other words, each wire nozzle 31 feeds the wire W to the machining point 111 on the target additive face 110 of the workpiece 100.

Instead of feeding the wire W from the wire nozzle 31 to the machining point 111, the additive manufacturing apparatus 1 can adopt a forming method in which powdered metal as a process material is ejected from a nozzle. In cases where the powdered metal is used as the process material, a method of using a negative pressure of the shielding gas G, a method by which pressurizing and ejecting the powdered metal from a powder delivery tube that transfers the powdered metal is timed to forming, or another method is usable. In such cases, the nozzle that ejects the powdered metal is disposed such that the powdered metal is ejected in a columnar shape having a central axis corresponding to a central axis of the wire W that is fed to the machining point 111. The wire W and the powdered metal to be ejected in the columnar shape both refer to a process material that is fed in a columnar shape from the nozzle to the machining point 111.

The gas nozzle 41 ejects toward the machining point 111 on the target additive face 110 the shielding gas G that restrains or prevents oxidation of the additive manufactured object 220 and cools the beads. The beam nozzle 23, the wire nozzles 31, and the gas nozzle 41 are fixed to the machining head 21, thus having a uniquely determined positional relation. In other words, relative positions of the beam nozzle 23, the wire nozzles 31, and the gas nozzle 41 are fixed at the machining head 21.

The head actuator 22 moves the machining head 21 in directions, namely, X-axis directions, Y-axis directions, and Z-axis directions. The head actuator 22 includes a servomotor that, in a motion mechanism, moves the machining head 21 in the X-axis directions, a servomotor that, in the motion mechanism, moves the machining head 21 in the Y-axis directions, and a servomotor that, in the motion mechanism, moves the machining head 21 in the Z-axis directions. The head actuator 22 is the motion mechanism that enables translations in the directions along the three axes. The servomotors are not illustrated in FIG. 1. In the additive manufacturing apparatus 1, the head actuator 22 moves the machining head 21, enabling the irradiation position for the laser beam L to shift on the target additive face 110.

The machining head 21 illustrated in FIG. 1 causes the laser beam L to travel in the Z-axis direction from the beam nozzle 23. Each wire nozzle 31 is provided at the position away from the beam nozzle 23 in an XY plane and advances the wire W in a direction oblique to the Z-axis. In other words, the wire W is advanced by the wire nozzle 31 without being coaxial with the laser beam L that is emitted from the beam nozzle 23. The wire nozzle 31 is used to limit the movement of the wire W for feeding the wire W to a desired position.

At the machining head 21, the gas nozzle 41 is provided coaxially with the beam nozzle 23 around an outer periphery of the beam nozzle 23 in the XY plane and ejects the shielding gas G along a central axis of the laser beam L that is emitted from the beam nozzle 23. In other words, the beam nozzle 23 and the gas nozzle 41 are arranged coaxially with each other.

Although not illustrated, the wire nozzle 31 may be coaxial with the beam nozzle 23. A conceivable configuration in this case has the wire nozzle 31 disposed in a center, and a gas ejection outlet of the gas nozzle 41 and a laser emission outlet of the beam nozzle 23 are arranged in ring shapes centering around the wire W or as plural points surrounding a center of the wire W. In this case, the laser beam L is emitted in the form of a ring or plural points from the beam nozzle 23 and focuses on the wire W near the machining point 111.

The additive manufacturing apparatus 1 further includes a laser oscillator 24 that emits the oscillated laser beam L, which is to be emitted for irradiation from the beam nozzle 23 of the machining head 21, and a gas supply unit 42 that supplies the shielding gas G to the gas nozzle 41 of the machining head 21. A fiber cable 25 is connected between the laser oscillator 24 and the machining head 21. The laser beam L generated by the laser oscillator 24 propagates via the fiber cable 25 to the beam nozzle 23. A pipe 43 is connected between the gas supply unit 42 and the machining head 21. The shielding gas G is supplied from the gas supply unit 42 through the pipe 43 to the gas nozzle 41.

The laser oscillator 24, the fiber cable 25, and the beam nozzle 23 form an irradiation unit that irradiates the target additive face 110 with the laser beam L that melts the wire W and is not coaxial with the central axis of the wire W. The gas supply unit 42, the pipe 43, and the gas nozzle 41 form a gas supply mechanism that ejects the shielding gas G toward the machining point 111.

The additive manufacturing apparatus 1 further includes a wire spool 33 and a rotary motor 34. The wire spool 33 is a process material supply source and is wound with the wire W. The rotary motor 34 rotates the wire spool 33. The rotary motor 34 is, for example, a servomotor. As the rotary motor 34 is driven, the wire spool 33 is rotated, and the wire W is drawn from the wire spool 33. The wire W drawn from the wire spool 33 is passed through the wire nozzle 31 to be fed to the machining point 111. The rotary motor 34, the wire spool 33, and the wire nozzle 31 form a wire supply unit 32.

Since the additive manufacturing apparatus 1 stacks plural kinds of metal in the first embodiment, the additive manufacturing apparatus 1 has a plurality of the wire supply units 32. However, only one of the wire supply units 32 is illustrated in FIG. 1. Given below is an example of a forming method using two kinds of wires W. In other words, in the example given, the wire supply units 32 included in the additive manufacturing apparatus 1 are two. In this case, one of the wire supply units 32 has a first wire nozzle that feeds a first wire made of a first metallic material, and the other wire supply unit 32 has a second wire nozzle that feeds a second wire made of a second metallic material. The first metallic material and the second metallic material may be metals consisting of single metallic elements or alloys consisting of plural metallic compounds. The first and second metallic materials to be selected are a combination of materials that forms an intermetallic compound. In the first embodiment, the first and second metallic materials have the same strength for simplification of description.

The additive manufacturing apparatus 1 includes a rotation mechanism 13 that rotates the stage 11. The rotation mechanism 13 is a motion mechanism that enables rotation of the stage 11 about the X-axis and rotation of the stage 11 about the Z-axis. The rotation may be about the Y-axis instead of the X-axis. The rotation mechanism 13 includes a servomotor that, in the motion mechanism, causes the stage 11 to rotate about the X-axis or the Y-axis and a servomotor that, in the motion mechanism, causes the stage 11 to rotate about the Z-axis. The rotation mechanism 13 is the motion mechanism that enables the rotations about the two axes. The servomotors are not illustrated in FIG. 1. The additive manufacturing apparatus 1 is capable of changing a posture or a position of the workpiece 100 by rotating the stage 11 with the rotation mechanism 13. The use of the rotation mechanism 13 enables formation of a complex shape that includes a taper. With the rotation mechanism 13 for the stage 11 and the above-described head actuator 22 combined, the additive manufacturing apparatus 1 is capable of a 5-axis drive.

The additive manufacturing apparatus 1 includes a control unit 51 that controls the additive manufacturing apparatus 1 in accordance with a processing program. The processing program designates a movement path along which the machining head 21 is to be moved relative to the workpiece 100 placed on the stage 11.

The control unit 51 controls the laser oscillator 24, the wire supply units 32, and the gas supply unit 42 and is responsible for controlling formation of the plural dot-shaped beads that are formed by melting the wires W into the additive manufactured object 220. The control unit 51 is, for example, a numerical control apparatus. The control unit 51 outputs move commands to the head actuator 22 in performing drive control on the head actuator 22 to move the machining head 21. The control unit 51 outputs a command in accordance with a beam power condition to the laser oscillator 24 in controlling laser oscillation of the laser oscillator 24.

The control unit 51 outputs a command in accordance with a feed quantity condition for the wire W to the rotary motor 34 in performing drive control on the rotary motor 34. By performing the drive control on the rotary motor 34, the control unit 51 adjusts a speed of the wire W from the wire spool 33 to the irradiation position. In other words, the control unit 51 controls feed quantities for the wires W of the plural wire supply units 32.

The control unit 51 outputs a command in accordance with a supply quantity condition for the shielding gas G to the gas supply unit 42 in controlling a quantity of shielding gas G to be supplied from the gas supply unit 42 to the gas nozzle 41. The control unit 51 outputs rotation commands to the rotation mechanism 13 in performing drive control on the rotation mechanism 13. In other words, the control unit 51 controls the entire additive manufacturing apparatus 1 by outputting the various commands.

The control unit 51 is capable of changing the machining point 111 by having the head actuator 22 and the rotation mechanism 13 operate in conjunction with each other to move the machining head 21 and the stage 11, so the additive manufactured object 220 of a desired shape is obtainable.

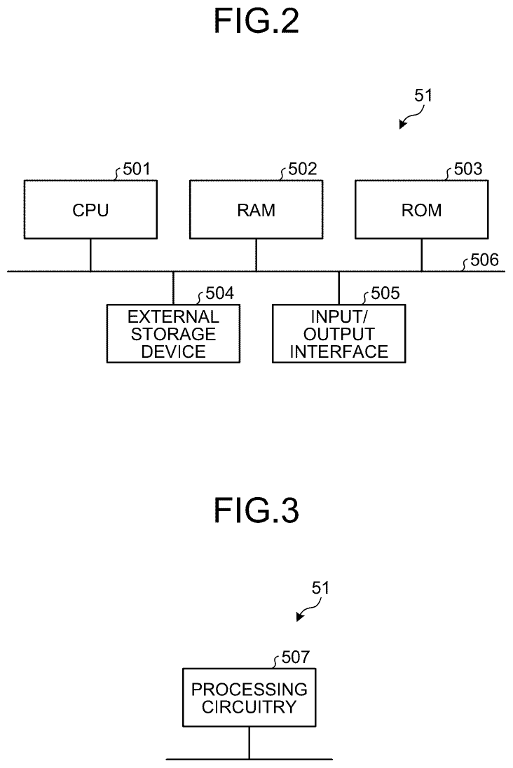

FIG. 2 is a block diagram illustrating a first example of a hardware configuration for the control unit of the additive manufacturing apparatus according to the first embodiment. The control unit 51 is implemented using a control program that is a program for executing the control of the additive manufacturing apparatus 1.

The control unit 51 includes a central processing unit (CPU) 501 that executes various processes, a random access memory (RAN) 502 that includes a data storage area, a read only memory (ROM) 503 that is a nonvolatile memory, an external storage device 504, and an input/output interface 505 that inputs information to the control unit 51 and outputs information from the control unit 51. In FIG. 2, the parts are interconnected via a bus 506.

The CPU 501 executes programs stored in the ROM 503 and the external storage device 504. The overall control of the additive manufacturing apparatus 1 by the control unit 51 is implemented using the CPU 501.

The external storage device 504 is a hard disk drive (HDD) or a solid state drive (SSD). The external storage device 504 stores the control program and various data. The ROM 503 stores software or a program that performs hardware control, namely a program that performs basic control of a computer or controller that serves as the control unit 51, such as a Basic Input/Output System (BIOS) boot loader or a Unified Extensible Firmware Interface (UEFI) boot loader. The control program may be stored in the ROM 503.

The programs stored in the ROM 503 and the external storage device 504 are loaded into the RAM 502. The CPU 501 loads the control program in the RAM 502 and executes various processes. The input/output interface 505 is an interface that provides connection with a device external to the control unit 51. The processing program is input to the input/output interface 505. The input/output interface 505 outputs the various commands. The control unit 51 may include input devices, such as a keyboard and a pointing device, and an output device, such as a display.

The control program may be stored in a storage medium readable by the computer. The control unit 51 may store the control program stored in the storage medium in the external storage device 504. The storage medium may be a portable storage medium that is a flexible disk or a flash memory that is a semiconductor memory. The control program may be installed on the computer or the controller that serves as the control unit 51 from another computer or a server device via a communication network.

FIG. 3 is a block diagram illustrating a second example of the hardware configuration for the control unit of the additive manufacturing apparatus according to the first embodiment. The functions of the control unit 51 can be implemented also by processing circuitry 507 that is dedicated hardware illustrated in FIG. 3. The processing circuitry 507 is a single circuit, a composite circuit, a programmed processor, a parallel programmed processor, an application specific integrated circuit (ASIC), a field-programmable gate array (FPGA), or a combination of these. Part of the functions of the control unit 51 may be implemented with dedicated hardware, with a different part of the functions implemented with software or firmware.

The additive manufacturing apparatus 1 forms on the target additive face 110 of the base member 12 the additive manufactured object 220 that uses the metallic materials by stacking the beads in plural layers. The beads are of the molten wires W added to the target additive face 110 of the base member 12 while the machining point 111 is shifted along the machining path. The beads are objects into which the molten wires W have solidified, forming the additive manufactured object 220.

A description is provided here of the additive manufactured object 220 that is obtained with the additive manufacturing apparatus 1 of FIG. 1. The additive manufacturing apparatus 1 forms the additive manufactured object 220 by stacking the beads; however, there cases where linear beads are used and cases where dot-shaped beads are used. The linear beads are hereinafter referred to as line beads, and the dot-shaped beads are hereinafter referred to as dot beads.

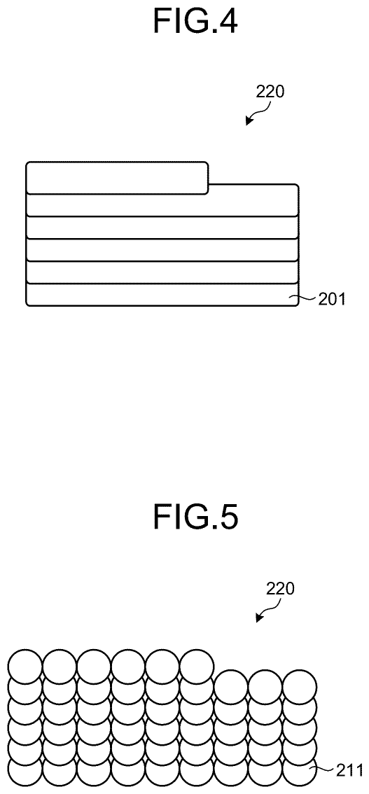

FIG. 4 is an enlarged view schematically illustrating an example of an object formed by line beads. A single line bead 201 is formed by continued irradiation of the machining point 111, which keeps shifting during the axial movement of the machining head 21, with the laser beam L and continued feeding of the wire W to the machining point 111. By repeating this process, an additive manufactured object 220 composed of a series of line beads 201 can be obtained. As seen from the above, the line bead 201 is a linear metal into which the molten wire W has solidified.

FIG. 5 is an enlarged view schematically illustrating an example of an object formed by dot beads. A single dot bead 211 is formed with the machining point 111 stopped without the axial movement of the machining head 21 in intermittent irradiation with the laser beam L and intermittent feeding of the wire W, and then an axial movement equivalent to a size of the single dot bead 211 is made. By repeating this process, an additive manufactured object 220 composed of a series of dot beads 211 can be obtained. As seen from the above, the dot bead 211 is a ball-shaped metal into which the molten wire W has solidified due to surface tension. Compared with the line bead 201, the dot bead 211 is formed with a low feed quantity of wire W and reduced heat input by the laser beam L and is thus small as the single bead. Moreover, the formation of the dot bead 211 involves no movement of the machining head 21, enabling the production of the additive manufactured object 220 that has high form accuracy compared with the formation of the line bead 201 that involves the movement of the machining head 21.

In cases where the wire W to be used has a thickness of about several millimeters, a diameter of the dot bead 211 that also depends on a beam diameter of the laser beam L is about several millimeters when the beam diameter is about several millimeters.

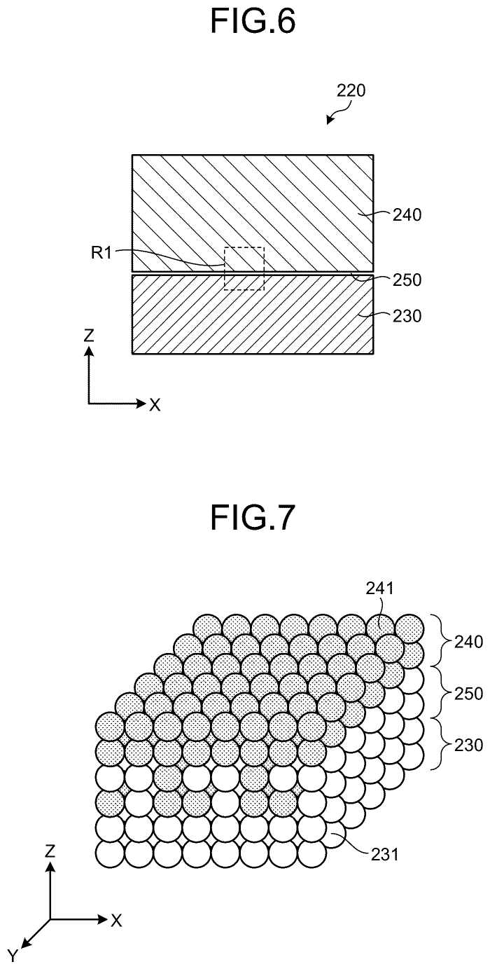

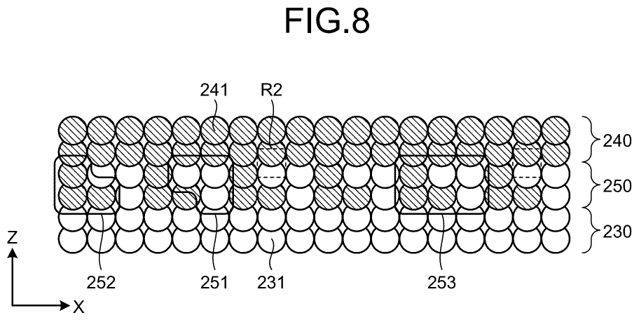

FIG. 6 is a sectional view illustrating an exemplary configuration of the additive manufactured object according to the first embodiment. FIG. 7 is a perspective partial view illustrating the exemplary configuration of the additive manufactured object according to the first embodiment. FIG. 8 is a partial sectional view illustrating the exemplary configuration of the additive manufactured object according to the first embodiment. Each of FIGS. 7 and 8 is an enlarged view of a portion of an area R1 in FIG. 6. In FIGS. 6 to 8, a left-to-right direction in a paper surface refers to the X-axis direction, a bottom-to-top direction refers to the Z-axis direction, and a direction perpendicular to the X-axis and Z-axis directions refers to the Y-axis direction. The Z-axis direction is a stacked direction of the dot beads 211.

As illustrated in FIG. 6, the additive manufactured object 220 is a stack including a first metal layer 230 made of the first metallic material and a second metal layer 240 made of the second metallic material. In other words, the additive manufactured object 220 is the object formed by stacking the different kinds of metal. As illustrated in FIG. 7, the first metal layer 230 is a three-dimensional stack of first dot beads 231 as dot beads made of the first metallic material, and the second metal layer 240 is a three-dimensional stack of second dot beads 241 as dot beads made of the second metallic material.

The additive manufactured object 220 according to the first embodiment includes the first metal layer 230, the second metal layer 240, and an intermediate layer 250 disposed between the first metal layer 230 and the second metal layer 240. The intermediate layer 250 includes a first structural part 251 as a structure made of the first metallic material and a second structural part 252 as a structure made of the second metallic material. The first structural part 251 and the second structural part 252 engage each other in a unit structure 253. In a plane perpendicular to the stacked direction of the first and second metal layers 230 and 240, an arrangement of a plurality of the unit structures 253 arranged in the intermediate layer 250 has translational symmetry, being a periodic arrangement. In the example illustrated in FIG. 8, the first structural part 251 is a hook-shaped structure that is composed of first dot beads 231 protruding from the first metal layer 230 to the second metal layer 240. The second structural part 252 is a hook-shaped structure that is composed of second dot beads 241 protruding from the second metal layer 240 to the first metal layer 230. A hook-shaped configuration of the first structural part 251 and a hook-shaped configuration of the second structural part 252 engage each other in the unit structure 253. The arrangement of the unit structures 253 has the translational symmetry in the plane perpendicular to the stacked direction of the first and second metal layers 230 and 240.

In the example illustrated in FIG. 8, the hook-shaped configuration of the first structural part 251 includes two first dot beads 231 stacked in the Z-axis direction and a first dot bead 231 that is arranged to be connected beside the second metal layer 240 to one of the first dot beads 231 that are stacked in the Z-axis direction and to protrude along the X-axis.

The hook-shaped configuration of the second structural part 252 includes two second dot beads 241 stacked in the Z-axis direction and a second dot bead 241 that is arranged to be connected beside the first metal layer 230 to one of the second dot beads 241 that are stacked in the Z-axis direction and to protrude along the X-axis.

The hook-shaped configuration of the first structural part 251 and the hook-shaped configuration of the second structural part 252 are in interlocking engagement, thus forming the unit structure 253. In this example, the unit structure 253 has a Y-axis thickness equivalent to one dot bead. The unit structures 253 are arranged along the X- and Y-axes, forming the intermediate layer 250.

The dot beads illustrated in FIGS. 7 and 8 are each as small as about several millimeters, as described above, and are not large enough to clearly make the engagement part between the first structural part 251 and the second structural part 252 visible when viewed as a final product configuration. Therefore, the presence of the engagement parts does not restrict a shape and a size of a final product.

Since the arrangement of the unit structures 253 has the translational symmetry at a junction interface between the first metal layer 230 and the second metal layer 240, that is to say, the engagement parts are uniformly present at the junction interface, the junction interface between the first and second metal layers 230 and 240 has uniform bond strength against pulling directions or the Z-axis directions. The engagement configuration of the first structural part 251 and the second structural part 252 that is illustrated in FIGS. 7 and 8 is an example, and another engagement configuration may be used. Since the arrangement of the unit structures 253 has the translational symmetry at the junction interface between the first and second metal layers 230 and 240, the unit structures 253 included in the intermediate layer 250 are two or more.

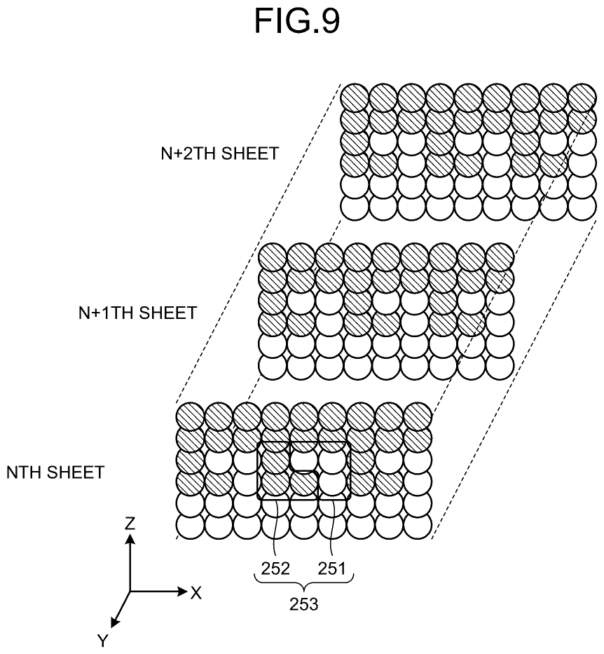

FIG. 9 is a diagram illustrating an exemplary configuration of the intermediate layer of the additive manufactured object according to the first embodiment. In FIG. 9, the unit structures 253 arranged at positions along the Y-axis have the respective first structural parts 251 and the respective second structural parts 252 at the same position along the X-axis. In FIG. 9, sheets that each have an arrangement of dot beads are respectively at consecutive positions along the Y-axis and are illustrated in spaced relation. With N being an integer greater than or equal to 0, an Nth sheet, an N+1th sheet, and an N+2th sheet that are consecutive along the Y-axis are illustrated here. As illustrated in FIG. 9, the first structural parts 251 in the Nth, N+1th, and N+2th sheets assume the same position along the X-axis, and the second structural parts 252 in the Nth, N+1th, and N+2th sheets assume the same position along the X-axis. In other words, Nth-sheet configurations are formed consecutively along the Y-axis.

Here a combination of the first structural part 251 and the second structural part 252 in the sheet at each position along the Y-axis may be considered the unit structure 253, or a combination of a whole group of first structural parts 251 formed along the Y-axis and a whole group of second structural parts 252 formed along the Y-axis may be considered the unit structure 253. In the latter case, the unit structures 253 are arranged along the X-axis, with their arrangement having translational symmetry.

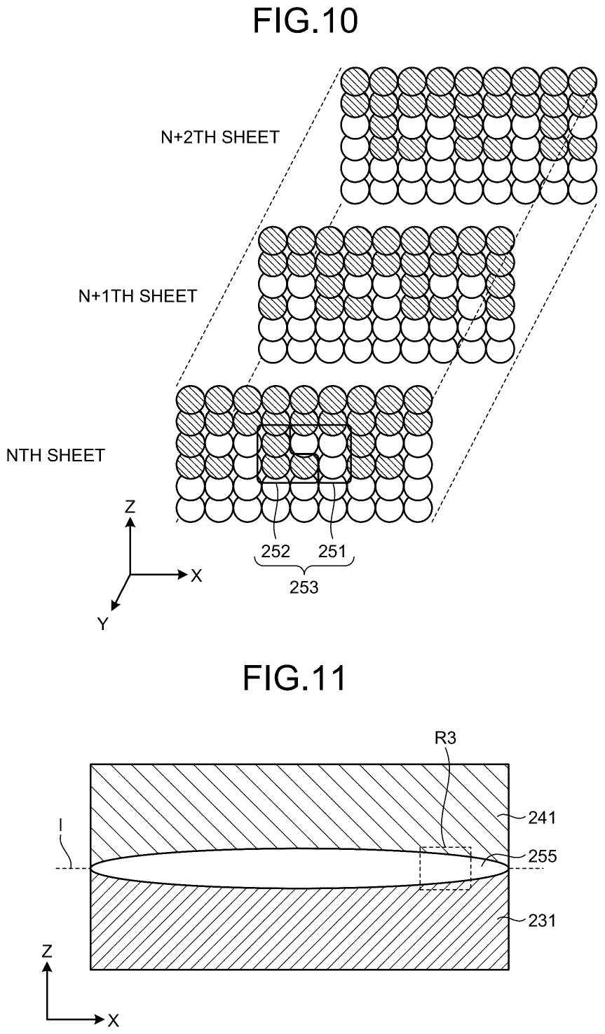

FIG. 10 is a diagram illustrating another exemplary configuration for the intermediate layer of the additive manufactured object according to the first embodiment. In FIG. 10, the first structural parts 251 and the second structural parts 252 arranged along the Y-axis have their respective positions along the X-axis shifted. While FIG. 10 illustrates the case where the position shifts by one bead along the X-axis for every sheet shift in the Y-axis direction, the position may shift by a predetermined number of beads along the X-axis for every predetermined number of sheet shifts in the Y-axis direction. In that case, the unit structure 253 includes an arrangement of a predetermined number of first structural parts 251 along the Y-axis and a predetermined number of second structural parts 252 along the Y-axis.

A description is provided next of details of a junction interface part between the first dot bead 231 made of the first metallic material and the second dot bead 241 made of the second metallic material in the intermediate layer 250. FIG. 11 is a diagram schematically illustrating an example of the junction interface between the first dot bead and the second dot bead in the additive manufactured object according to the first embodiment. FIG. 11 is an enlarged schematic view of an area R2 in FIG. 8. Since the selected first and second metallic materials are, as described above, the materials that form the intermetallic compound, an intermetallic compound layer 255 that includes the intermetallic compound is formed at the junction interface I between the first dot bead 231 and the second dot bead 241. While the intermetallic compound layer 255 includes the intermetallic compound, the intermetallic compound layer 255 may or may not include a solid solution and another phase.

Intermetallic compounds are generally known to exhibit unique properties different from those of original metals. The intermetallic compound layer 255 is a third layer having properties different from those of the first and second metallic materials. The intermetallic compound layer 255 formed at the junction interface I between the first and second dot beads 231 and 241 has the role of a barrier layer. The intermetallic compound layer 255 does not have the role of bonding the first dot bead 231 and the second dot bead 241 together. In cases where the first and second metallic materials have different coefficients of thermal expansion, the intermetallic compound layer 255 is capable of lessening thermal strain resulting from a difference between the coefficients of thermal expansion. In other words, the intermetallic compound layer 255 has the role of a cushioning member.

Since the intermetallic compound layer 255 does not bond the first and second dot beads 231 and 241 together, the mere formation of the second dot bead 241 on the first dot bead 231 does not provide a sufficient bond between the first metal layer 230 and the second metal layer 240. Accordingly, as illustrated in FIGS. 7 to 10, the first metal layer 230 and the second metal layer 240 are joined together in the first embodiment by the engagement between the hook-shaped first structural part 251 and the hook-shaped second structural part 252 of each of the unit structures 253 in the intermediate layer 250. For this reason, even in cases where the first and second metal layers 230 and 240 have the different coefficients of thermal expansion, a bond between the first and second metal layers 230 and 240 can be maintained by the way the first and second dot beads 231 and 241 are physically arranged in the intermediate layer 250.

If the first metal layer 230 and the second metal layer 240 are in contact, a potential difference across the junction interface I causes electricity to flow, and corrosion is likely to occur. In the first embodiment, on the other hand, the intermetallic compound layer 255 is present between the first dot bead 231 and the second dot bead 241. Since many intermetallic compounds do not conduct electricity, even when the potential difference occurs between the first metal layer 230 and the second metal layer 240, the intermetallic compound cuts off the flow. Consequently, corrosion is less likely to occur at the junction interface I between the first metal layer 230 and the second metal layer 240.

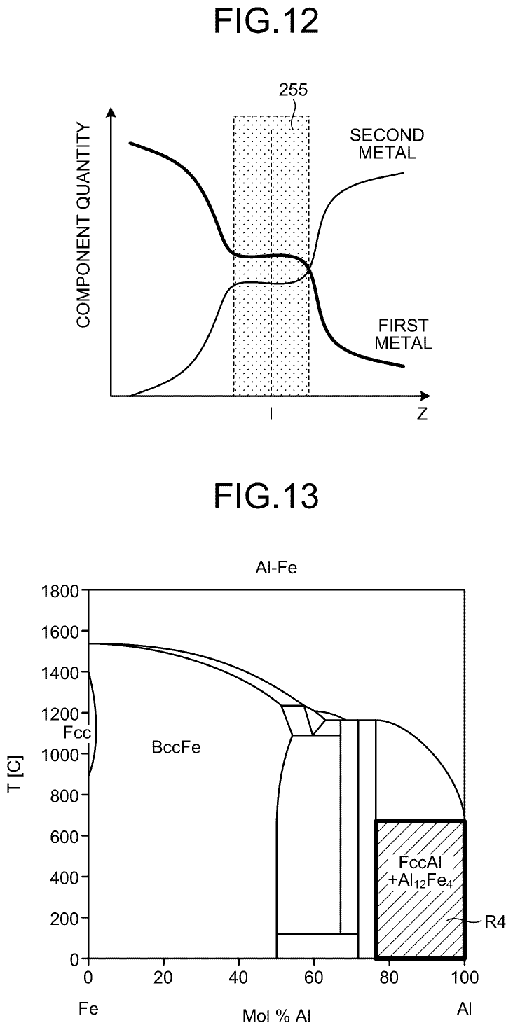

FIG. 12 is a diagram illustrating an example of a state of components at the junction interface between the first dot bead and the second dot bead in the additive manufactured object according to the first embodiment. In this case, the first metallic material is made from a first metal, and the second metallic material is made from a second metal. Moreover, the first metal and the second metal are a combination that does not form a solid solution but forms an intermetallic compound. In FIG. 12, a horizontal axis represents positions along the Z-axis in the additive manufactured object 220, including the junction interface I between the first and second dot beads 231 and 241, and a vertical axis represents a component quantity for each of the first and second metals. FIG. 12 illustrates how the components, namely the first and second metals change in quantity along the Z-axis in an area R3 of FIG. 11.

The intermetallic compound is a result of combining the first and second metals in a predetermined ratio. Therefore, as illustrated in FIG. 12, the intermetallic compound layer 255 around the junction interface I has both the first and second metals as the components in constant quantities. For this reason, whether or not the intermetallic compound layer 255 is formed at the junction interface I can be easily determined by component analysis using an energy dispersive X-ray spectroscopy (EDS) system or another system that comes with a scanning electron microscope (SEM) or another microscope.

A description is provided of an example case where the first metallic material is Fe and the second metallic material is Al. FIG. 13 is a phase diagram of Al—Fe. Using Al as a basis metal and Fe as an added metal as in a region R4 of FIG. 13 provides an intermetallic compound layer 255 that includes only an intermetallic compound or the intermetallic compound and a solid solution. In the first embodiment, the intermetallic compound needs to be formed in the intermetallic compound layer 255 regardless of whether the solid solution is formed or not. In the region R4 illustrated, Al having a face-centered cubic structure and Al₁₂Fe₄ are formed.

In the formation of the second dot bead 241 made of Al on the first dot bead 231 made of Fe, Fe from a portion defining the first dot bead 231 mixes with the molten Al. As a result, the intermetallic compound as in the region R4 of the phase diagram is obtained around the junction interface I between the first dot bead 231 and the second dot bead 241.

While Al—Fe is given as the example in the description here, a different combination of first and second metallic materials that forms an intermetallic compound similarly forms the intermetallic compound at the junction interface I between the first and second dot beads 231 and 241.

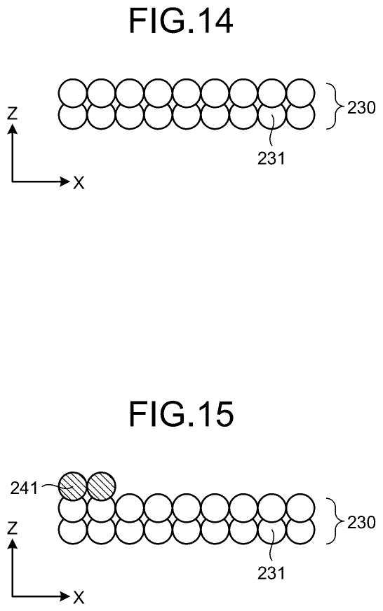

A description is provided next of a method of manufacturing the additive manufactured object 220. FIGS. 14 to 18 are sectional views schematically illustrating a procedural example of the method of manufacturing the additive manufactured object according to the first embodiment. As illustrated in FIG. 14, the first dot beads 231 made of the first metallic material are arranged in a desired shape first, thus forming the first metal layer 230. A molten pool is formed with the additive manufacturing apparatus 1 illustrated in FIG. 1 by irradiating the machining point 111 with the laser beam L from the beam nozzle 23. In this state, the first wire made of the first metallic material is fed from the wire nozzle 31 to the machining point 111. The machining point 111 is irradiated with the laser beam L, so that the first wire is melt heated to form a first dot bead 231. In this case, the machining head 21 is moved in the Y-axis direction after the one first dot bead 231 is formed, and another first dot bead 231 to follow is formed. After a row of first dot beads 231 that extends in the Y-axis direction is formed, the machining head 21 is moved by a width of the dot bead in the X-axis direction, and the process of forming a row of first dot beads 231 that extends in the Y-axis direction is repeated.

Next, while the first-wire feed to the machining point 111 and the second-wire feed to the machining point 111 are switched, the hook-shaped first structural parts 251 and the hook-shaped second structural parts 252 are formed on the first metal layer 230, thus forming the intermediate layer 250. In other words, to provide between the first and second metal layers 230 and 240 the arrangement of the unit structures 253 that has the translational symmetry in the plane perpendicular to the stacked direction of the first and second metal layers 230 and 240 and includes the first and second structural parts 251 and 252 that engage each other in the unit structure 253, the control unit 51 stops the machining point by no axial movement of the machining head 21 in intermittently causing the irradiation with the laser beam L and the feeding of the first or second wire.

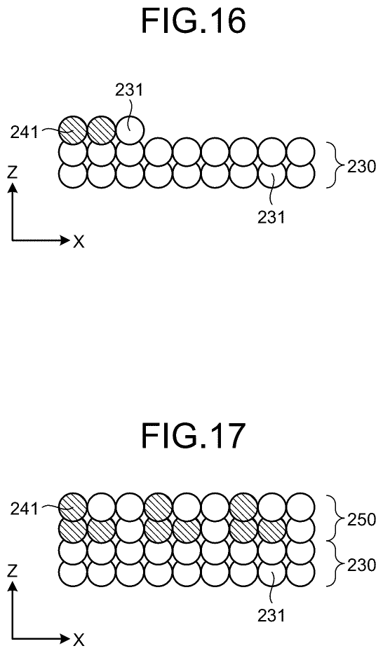

Specifically, as illustrated in FIG. 15, the second dot bead 241 for the second structural part 252 is formed at a predetermined position on the first metal layer 230. In this formation, a molten pool is formed with the additive manufacturing apparatus 1 by irradiating the machining point 111 with the laser beam L from the beam nozzle 23. In this state, the second wire made of the second metallic material is fed to the machining point 111. The machining point 111 is irradiated with the laser beam L, so that the second wire is melt heated to form the second dot bead 241. Here second dot beads 241 are similarly formed one after another along the Y-axis. Thereafter, as illustrated in FIG. 16, each of first dot beads 231 is formed by forming a molten pool by irradiation of the machining point 111 with the laser beam L from the beam nozzle 23, feeding the first wire to the machining point 111, and then irradiating the machining point 111 with the laser beam L. By repeatedly executing the processes of FIGS. 15 and 16, the intermediate layer 250 is obtained as illustrated in FIG. 17, having the arrangement of the unit structures that has the translational symmetry, with the hook-shaped first structural part 251 and the hook-shaped second structural part 252 in engagement in the unit structure.

When the second dot bead 241 is formed on the first dot bead 231, the intermetallic compound layer 255 is formed at the junction interface I between the first dot bead 231 and the second dot bead 241. When the first dot bead 231 is formed on the second dot bead 241, the intermetallic compound layer 255 is formed at the junction interface I between the first dot bead 231 and the second dot bead 241.

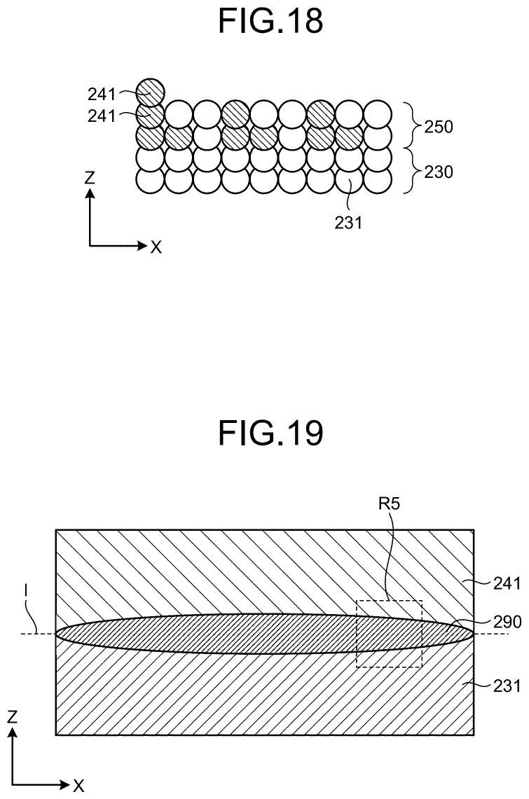

Thereafter, as illustrated in FIG. 18, the second dot beads 241 are formed on the intermediate layer 250, thus forming the second metal layer 240. Here the second dot beads 241 are similarly formed one after another along the Y-axis. The additive manufactured object 220 illustrated in FIGS. 7 and 8 is thus formed. That ends the method of manufacturing the additive manufactured object 220 that includes the first and second metallic materials.

A description is provided here of a difference from a prior art that forms a solid solution at an interface between a first dot bead 231 and a second dot bead 241. FIG. 19 is a diagram schematically illustrating an example of the junction interface between the first dot bead and the second dot bead in a prior art additive manufactured object. FIG. 19 is an enlarged schematic view of a portion that corresponds to the area R2 of FIG. 8. In FIG. 19, constituent elements identical with those in the first embodiment have the same reference characters and are not described. A selected first metal and a selected second metal are materials that form the solid solution, so a solid solution layer 290 made of the solid solution is formed at the junction interface I between the first dot bead 231 and the second dot bead 241, as illustrated in FIG. 19.

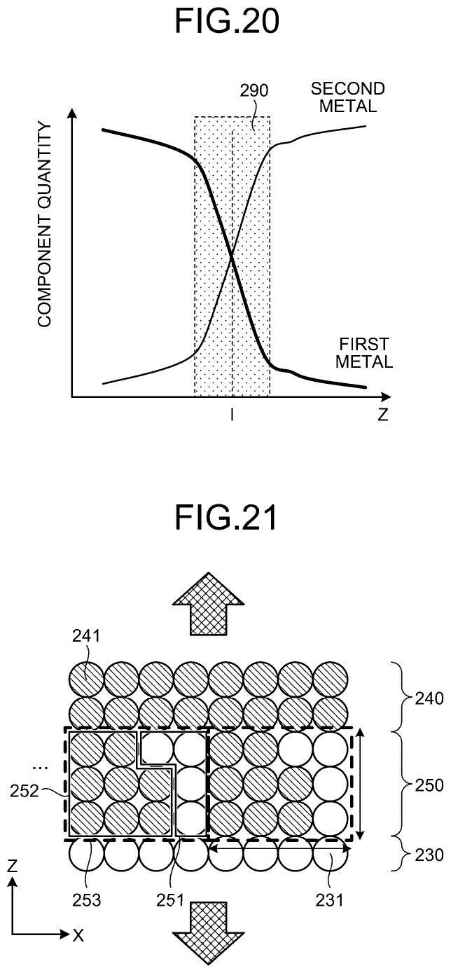

FIG. 20 is a diagram illustrating an example of a state of components at the junction interface between the first dot bead and the second dot bead according to the prior art. In this case, the first metallic material is made of the first metal, and the second metallic material is made of the second metal. Moreover, the first metal and the second metal are a combination that forms the solid solution. In FIG. 20, a horizontal axis represents positions along the Z-axis in the additive manufactured object 220, including the junction interface I between the first and second dot beads 231 and 241, and a vertical axis represents a component quantity for each of the first and second metals. FIG. 20 illustrates how the components, namely the first and second metals change in quantity along the Z-axis in an area R5 of FIG. 19.

In the solid solution, the original metals have undergone a continuous compositional change. Therefore, as illustrated in FIG. 20, the first metal as the component continuously decreases in quantity from an interface between the solid solution layer 290, which is formed at the junction interface I between the first and second dot beads 231 and 241, and the first dot bead 231 to an interface between the solid solution layer 290 and the second dot bead 241. The second metal as the component continuously increases in quantity from the interface between the solid solution layer 290 and the first dot bead 231 to the interface between the solid solution layer 290 and the second dot bead 241. Both the components, namely the first and second metals slope gently this way in the solid solution layer 290 at the junction interface I.

Having the original metals that have undergone the continuous compositional change, the solid solution usually exhibits properties similar to those of the original metals. For this reason, the solid solution layer 290 made of the solid solution bonds the first dot bead 231 and the second dot bead 241 together. Therefore, in cases where the first and second metallic materials have different coefficients of thermal expansion, thermal strain resulting from a difference between the coefficients of thermal expansion causes separation at the solid solution layer 290. Where there is the separation, the first dot bead 231 and the second dot bead 241 are no longer bonded together, causing separation between the first metal layer 230 and the second metal layer 240.

Many solid solutions of first and second metals are electrically conductive. Therefore, if the first metal layer 230 and the second metal layer 240 are in contact through the solid solution layer 290, a potential difference across the junction interface I causes electricity to flow, and corrosion is likely to occur.

The additive manufactured object 220 according to the first embodiment includes the intermediate layer 250 between the first metal layer 230 made of the first metallic material and the second metal layer 240 made of the second metallic material. The intermediate layer 250 includes the first structural part 251 as the hook-shaped structure that is composed of the first dot beads 231 protruding from the first metal layer 230 to the second metal layer 240 and the second structural part 252 as the hook-shaped structure that is composed of the second dot beads 241 protruding from the second metal layer 240 to the first metal layer 230. The first structural part 251 and the second structural part 252 engage each other in the unit structure 253. The arrangement of the unit structures 253 arranged in the intermediate layer 250 has the translational symmetry in the plane perpendicular to the stacked direction of the first and second metal layers 230 and 240. Therefore, the additive manufactured object 220 has effects of not being limited in terms of the combination of the first metallic material and the second metallic material as compared with a conventional one and ensuring uniform bond strength at the junction interface I between the first metal layer 230 and the second metal layer 240. In addition, the engagement between the first structural part 251 and the second structural part 252 in the unit structure 253 is done by the physical arrangement of the first and second dot beads 231 and 241 and is millimeter-sized. Therefore, the unit structure 253 that has the engagement does not restrict the shape and the size of the final product, enabling the formation of the additive manufactured object 220 of any shape and size.

The intermetallic compound layer 255 does not bond the first and second dot beads 231 and 241 together. Even in cases where the coefficients of thermal expansion of the first and second metallic materials are different and cause thermal strain at the junction interface I between the first and second dot beads 231 and 241, the intermetallic compound layer 255 functions as the cushioning member for the thermal strain. Moreover, in cases where the intermetallic compound layer 255 is not electrically conductive, the electricity does not flow through the junction interface I between the first and second metal layers 230 and 240 even when the potential difference is caused because of the contact between the first and second dot beads 231 and 241, thus enabling progressive corrosion to be restrained.

### Second Embodiment

In FIG. 8 of the first embodiment, there is no difference in strength between the first metallic material and the second metallic material; however, there are cases where an actual material combination has a difference in strength between a first metallic material and a second metallic material. In such cases, a ratio of how many first dot beads 231 to be arranged in the unit structure 253 to how many second dot beads 241 to be arranged in the unit structure 253 is varied according to the strength between the first and second metallic materials.

Suppose that the first metallic material has a tensile strength twice that of the second metallic material here. FIG. 21 is a partial sectional view illustrating an exemplary configuration of an additive manufactured object according to a second embodiment. Since the tensile strength of the second metallic material is half the tensile strength of the first metallic material, in FIG. 21, a Z-axis extended portion of the second structural part 252 includes, in an X-axis direction, second dot beads 241 that are, in number, twice a first dot bead 231 that a Z-axis extended portion of the first structural part 251 includes in an X-axis direction. In this way, a Z-axis tensile strength of the second dot beads 241 becomes equal to that of the first dot bead 231, and junction loads that act on an interface in pulling directions, namely along a Z-axis are enabled to improve.

It is to be noted that this case is an example. The ratio of how many first dot beads 231 the first structural part 251 is to include to how many second dot beads 241 the second structural part 252 is to include can be varied according to the strength ratio between the first and second metallic materials.

In the second embodiment, the ratio of how many first dot beads 231 the first structural part 251 includes to how many second dot beads 241 the second structural part 252 includes varies according to the strength ratio between the first and second metallic materials. This enables a strength of the junction interface I between the first metal layer 230 and the second metal layer 240 to remain constant even when there are mixed dot beads of different strengths.

### Third Embodiment

In the case described in the second embodiment, when the metallic materials have different strengths difference in terms of the tensile strength along the one axis, the ratio between the numbers of dot beads in the unit structure 253 is adjusted to solve the strength difference between the metallic materials. In a third embodiment, a description is provided of a configuration of an additive manufactured object 220 that can also maintain bond strength of an interface between the first metal layer 230 and the second metal layer 240 in cases where strengths act in directions other than along the one axis.

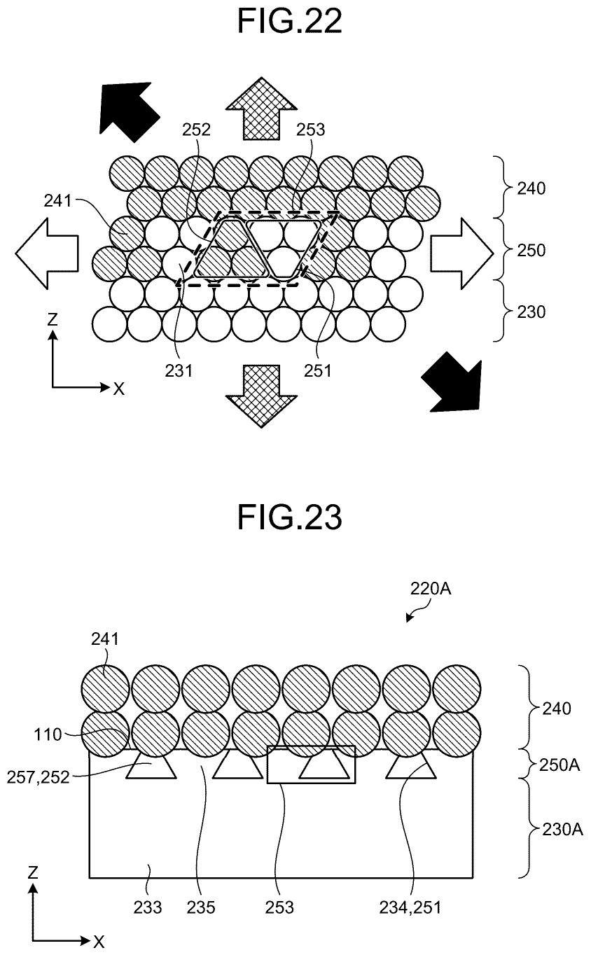

In the first embodiment, as illustrated in FIG. 8, the dot bead is put on the lower-layer dot bead to be at the same position as the lower-layer dot bead along the X-axis and the Y-axis. However, since the dot bead is substantially spherical, a packing ratio can be freely changed. FIG. 22 is a diagram illustrating an example of how dot beads are arranged in the additive manufactured object according to the third embodiment. FIG. 22 illustrates the case where the dot beads are arranged in face-centered cubic lattices. When viewed from a Y-axis direction, on an Mth dot bead layer composed of dot beads, an M+1th dot bead layer is formed in a Z-axis direction such that each of its dot beads is shifted a distance equal to one half of a bead width along an X-axis, where M is an integer greater than or equal to 0. Similar arrangements are provided throughout the first metal layer 230, the intermediate layer 250, and the second metal layer 240. While FIG. 22 is a view as seen from the Y-axis direction, the same is true when viewed from an X-axis direction. In this case, the first and second dot beads 231 and 241 are arranged such that the face-centered cubic lattice arrangement is maintained also in the intermediate layer 250 and form the hook-shaped first structural parts 251 and the hook-shaped second structural parts 252. Consequently, the unit structures 253 are formed in the intermediate layer 250.

Arranging the dot beads in the face-centered cubic lattices throughout the additive manufactured object 220 increases the dot bead packing ratio. In this way, the bond strength can also be improved against, besides tension, loads along multiple axes or in specific directions, as indicated by plural arrows in FIG. 22, such as bending, shear, compression, and torsion.

Instead of being arranged in the face-centered cubic lattices, the dot beads can also be arranged in a close-packed hexagonal lattice structure, a body-centered cubic lattice structure or another structure. Shifting the dot beads to be arranged thus enables the strength in any direction to change. In other words, the additive manufactured object 220 that has the strength based on the lattice structure is obtainable.

Generally, slip is likely to occur along a close-packed plane, so the strength reduces at the close-packed plane. If, in an example, the intermediate layer 250 that includes the unit structure 253 in which the hook-shaped first structural part 251 and the hook-shaped second structural part 252 engage each other is provided in a direction that intersects the close-packed plane, increased strength is enabled at the slip plane.

In the case of the additive manufactured object 220 according to the third embodiment, the dot bead is shifted relative to the position of the dot bead in the lower dot bead layer when placed in the Z-axis direction. For example, the dot beads are arranged in the face-centered cubic lattices, body-centered cubic lattices or close-packed hexagonal lattices. Therefore, the additive manufactured object 220 has an effect of enabling increased strength against a load in a direction that is attributable to the lattice structure. In other words, anisotropic customization that provides the strength in the particular direction is enabled. Moreover, the engagement between the hook-shaped first structural part 251 and the hook-shaped second structural part 252 can be freely changed by the way the dot beads are arranged, enabling the bond strength specific to the particular direction to be provided.

### Fourth Embodiment

In the first through third embodiments, the first metal layer 230 is composed of the first dot beads 231. However, the first metal layer 230 does not have to be composed of the first dot beads 231. In a fourth embodiment, a description is provided of a case where the first metal layer 230 is a plate-shaped member.

FIG. 23 is a sectional view illustrating an exemplary configuration of an additive manufactured object according to the fourth embodiment. The additive manufactured object 220A includes a plate-shaped first metal layer 230A and the second metal layer 240 that are bonded together via an intermediate layer 250A. The first metal layer 230A is made of a first metallic material, and the second metal layer 240 is composed of the second dot beads 241 made of a second metallic material.

The first metal layer 230A is a member 233 of any shape. The member 233 includes, in its target additive face 110 where the second metal layer 240 is formed, an arrangement of grooves 234 that has translational symmetry. The grooves 234 may be grooves 234 extending along a Y-axis or grooves 234 of predetermined lengths that are arranged at predetermined intervals along the Y-axis. The grooves 234 are arranged at predetermined intervals also along an X-axis. A cross section of each of the grooves 234 that is perpendicular to the Y-axis, which refers to an extending direction of the groove 234, has a shape that tapers from a bottom to an opening. A part between the grooves 234 that are adjacent along the X-axis is referred to as a trapezoidal part 235. In one example, an upper face of the trapezoidal part 235 has an X-axis length equivalent to a size of one dot bead. As this is exemplary, the X-axis length of the upper face of the trapezoidal part 235 can be any length, provided that desired tensile strengths are obtainable throughout a part between the first metal layer 230A and the second metal layer 240.

Beads 257 made of the second metallic material are embedded in the grooves 234. In other words, the beads 257 engage in the grooves 234. Thus, the first structural part 251 corresponds to the groove 234, and the second structural part 252 corresponds to the bead 257 in the fourth embodiment. The bead 257 embedded in the groove 234 may be a line bead or include dot beads.

Second dot beads 241 are arranged on the first metal layer 230A with the beads 257 embedded in the grooves 234. These second dot beads 241 are bonded to the bead 257 in the groove 234 when arranged. Other second dot beads 241 are arranged on the trapezoidal part 235.

Bonding the bead 257 embedded in the taper groove 234 and the second dot beads 241 together prevents the bead 257 engaging in the groove 234 from easily coming out of the groove 234 when tensile stress acts along a Z-axis, enabling a firm bond between the first metal layer 230A and the second metal layer 240.

In this case, the portion including the groove 234, the bead 257 embedded in the groove 234, and the trapezoidal part 235 forms the unit structure 253. A part where an arrangement of the unit structures 253 has translational symmetry is the intermediate layer 250A. In cases where the line bead 257 is embedded in the groove 234, a combination of the groove 234 extending along the Y-axis, the bead 257 embedded in the groove 234, and the trapezoidal part 235 is the unit structure 253, so the intermediate layer 250 can be regarded as having an X-axis arrangement of the unit structures 253 that has translational symmetry. The intermetallic compound layer 255 is formed at an interface between the first metal layer 230A and the bead 257 as well as at an interface between the first metal layer 230A and the second dot bead 241 as with the one described in the first embodiment.

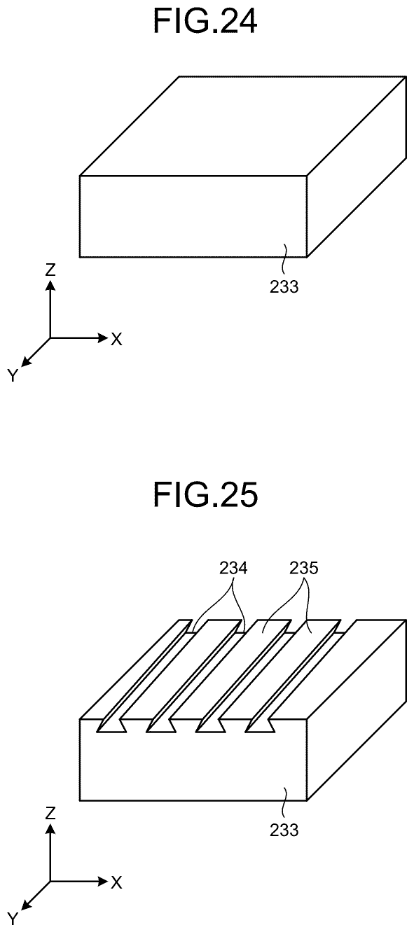

A description is provided next of a method of manufacturing such an additive manufactured object 220. FIGS. 24 to 30 are perspective views schematically illustrating a procedural example of the method of manufacturing the additive manufactured object according to the fourth embodiment. As illustrated in FIG. 24, the flat plate-shaped member 233 made of the first metallic material is prepared first. This flat plate-shaped member 233 becomes the first metal layer 230A. Next, as illustrated in FIG. 25, the grooves 234 that extend along the Y-axis are formed in an upper face of the first metal layer 230A at the predetermined intervals along the X-axis. The cross-sectional shape of the groove 234 that is perpendicular to the Y-axis tapers so that the groove 234 has a smaller area at the opening than at the bottom. In one example, the grooves 234 are formed by diesinking electric discharge machining. The formation of the grooves 234 creates the trapezoidal part 235 between the grooves 234.

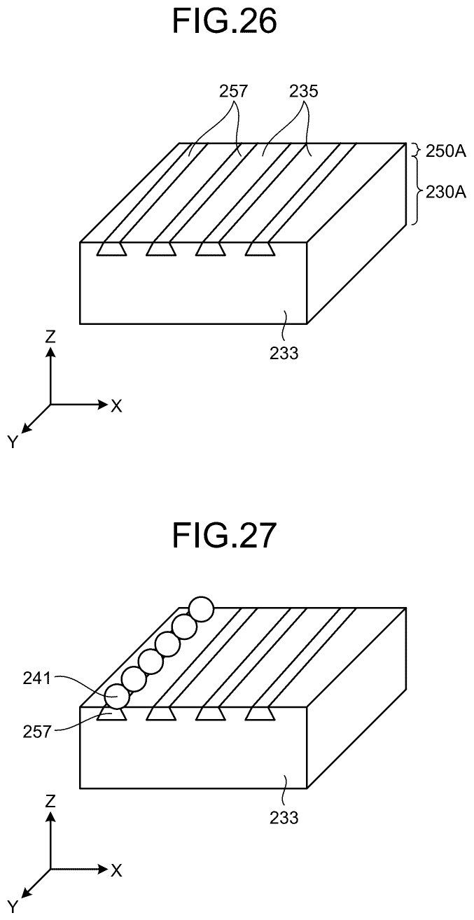

Thereafter, as illustrated in FIG. 26, the beads 257 made of the second metallic material are embedded in the grooves 234. As described above, the beads 257 may be the dot beads or the line beads. In this example, the beads 257 are the line beads. A section of the member 233 that includes the beads 257 embedded in the grooves 234 and the formed trapezoidal parts 235 is the intermediate layer 250A, and a remaining section of the member 233 is the first metal layer 230A.

Next, as illustrated in FIG. 27, the second dot beads 241 made of the second metallic material are formed on the bead 257 embedded in the groove 234 of the member 233. These second dot beads 241 are formed as a first row on and along the bead 257 that extends along the Y-axis.

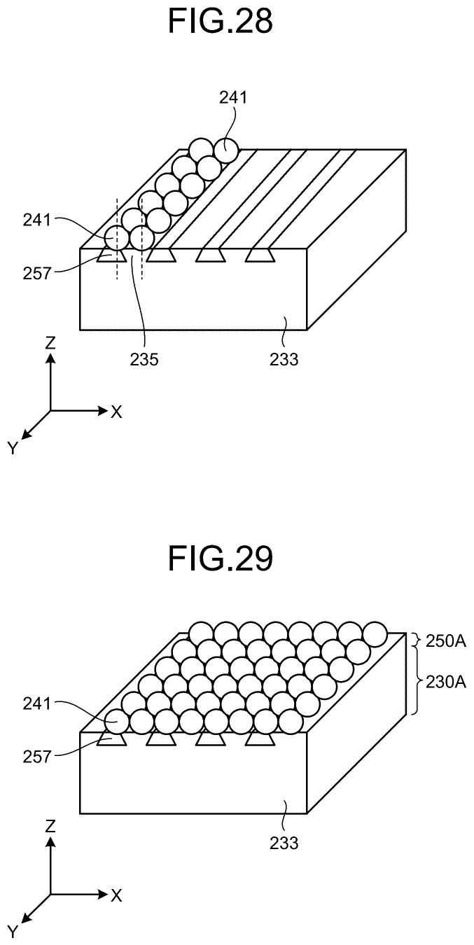

Thereafter, as illustrated in FIG. 28, the second dot beads 241 are formed as a second row along the Y-axis to be adjacent to the first-row second dot beads 241 along the X-axis on the trapezoidal part 235 of the member 233. The second-row second dot beads 241 are bonded to the first-row second dot beads 241 in a molten state.

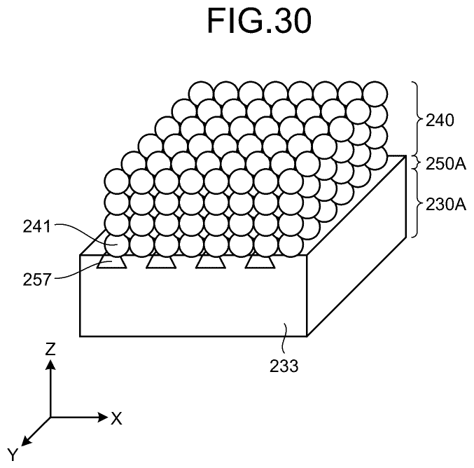

By repeatedly executing the processes of FIGS. 27 and 28, a first layer of second dot beads 241 illustrated in FIG. 29 is formed on the intermediate layer 250A. The same way as for the first layer of second dot beads 241 is repeated to form second-layer and subsequent-layer second dot beads 241. As a result, the second metal layer 240 illustrated in FIG. 30 is obtained. The member 233 is plate-shaped in the above description but does not have to be plate-shaped, provided that the member 233 is a member of any shape not formed by the first dot beads 231.

In the fourth embodiment, the first metal layer 230A is the member 233 of any shape that is not formed by the first dot beads 231. The grooves 234 that each have the cross section of taper shape are formed in this first metal layer 230A, and the beads 257 made of the second metallic material are embedded in the grooves 234. In this way, the intermediate layer 250A is formed. Next, the process of forming a row of second dot beads 241 on and along the embedded bead 257 and the process of forming on the trapezoidal part 235 a row of second dot beads 241 in contact with the previously formed row of second dot beads 241 are repeated to form the first-layer dot beads on the first metal layer 230A. This is repeated to form the second metal layer 240 composed of plural layers of second dot beads 241. Since this resulting configuration has the beads 257 engaging in the taper grooves 234, the same effects as those of the first embodiment are obtainable.

It takes time if the first metal layer 230A is formed by the first dot beads 231 because the first dot beads 231 are arranged three-dimensionally. However, in the fourth embodiment, the member 233 of any shape is used for the first metal layer 230A, enabling a short time required for the process of preparing the first metal layer 230A compared to when the first dot beads 231 are formed one by one to be arranged. The intermediate layer 250A is made by forming the grooves 234 in the member 233 by a method such as diesinking electric discharge machining and embedding the beads 257 in the grooves 234. This, too, enables a short time required for the process of forming the intermediate layer 250A compared to when the first dot beads 231 and the second dot beads 241 are arranged. Consequently, the production of the additive manufactured object 220 is enabled over a shorter time.

The above configurations illustrated in the embodiments are illustrative, can be combined with other techniques that are publicly known, and can be partly omitted or changed without departing from the gist. The embodiments can be combined together.

### REFERENCE SIGNS LIST

1 additive manufacturing apparatus; 11 stage; 12 base member; 13 rotation mechanism; 21 machining head; 22 head actuator; 23 beam nozzle; 24 laser oscillator; 25 fiber cable; 31 wire nozzle; 32 wire supply unit; 33 wire spool; 34 rotary motor; 41 gas nozzle; 42 gas supply unit; 43 pipe; 51 control unit; 100 workpiece; 110 target additive face; 111 machining point; 201 line bead; 211 dot bead; 220, 220A additive manufactured object; 230, 230A first metal layer; 231 first dot bead; 233 member; 234 groove; 235 trapezoidal part; 240 second metal layer; 241 second dot bead; 250, 250A intermediate layer; 251 first structural part; 252 second structural part; 253 unit structure; 255 intermetallic compound layer; 257 bead; 290 solid solution layer; G shielding gas; I junction interface; L laser beam; W wire.

1. An additive manufactured object as a stack that includes a first metal layer including first dot beads made of a first metallic material and a second metal layer including second dot beads made of a second metallic material, the additive manufactured object comprising:
an intermediate layer between the first metal layer and the second metal layer, the intermediate layer including a first structural part as a structure that includes the first dot beads and protrudes to the second metal layer while having a leading end beside the second metal layer protruding in a direction perpendicular to a stacked direction of the first metal layer and the second metal layer and a second structural part as a structure that includes the second dot beads and protrudes to the first metal layer while having a leading end beside the first metal layer protruding in a direction perpendicular to the stacked direction, the leading end of the first structural part and the leading end of the second structural part being in interlocking engagement in each of unit structures, an arrangement of the unit structures arranged in the intermediate layer having translational symmetry in a plane perpendicular to the stacked direction, wherein
the intermediate layer includes, at a junction interface between the first structural part and the second structural part, an intermetallic compound layer including an intermetallic compound, and
the first dot bead of the first structural part that protrudes in a direction perpendicular to the stacked direction and the second dot bead of the second structural part that protrudes in a direction perpendicular to the stacked direction are stacked in the stacked direction and are at an identical position in a plane perpendicular to the stacked direction.

2. An additive manufactured object as a stack that includes a first metal layer including first dot beads made of a first metallic material and a second metal layer including second dot beads made of a second metallic material, the additive manufactured object comprising:
an intermediate layer between the first metal layer and the second metal layer, the intermediate layer including a first structural part as a structure that includes the first dot beads and protrudes to the second metal layer while having a leading end beside the second metal layer protruding in a direction perpendicular to a stacked direction of the first metal layer and the second metal layer and a second structural part as a structure that includes the second dot beads and protrudes to the first metal layer while having a leading end beside the first metal layer protruding in a direction perpendicular to the stacked direction, the leading end of the first structural part and the leading end of the second structural part being in interlocking engagement in each of unit structures, an arrangement of the unit structures arranged in the intermediate layer having translational symmetry in a plane perpendicular to the stacked direction, wherein
the intermediate layer includes, at a junction interface between the first structural part and the second structural part, an intermetallic compound layer including an intermetallic compound, and
when a tensile strength of the first metallic material and a tensile strength of the second metallic material are different, how many of the first dot beads the unit structure has in a direction perpendicular to the stacked direction and how many of the second dot beads the unit structure has in a direction perpendicular to the stacked direction differ so as to provide a constant strength between the first structural part and the second structural part.

3. (canceled)

4. The additive manufactured object according to claim 2, wherein the first dot beads and the second dot beads that are arranged are each shifted relative to a lower-layer first dot bead position or a lower-layer second dot bead position.

5. The additive manufactured object according to claim 4, wherein the first dot beads and the second dot beads are arranged in one of a face-centered cubic lattice, a close-packed hexagonal lattice, and a body-centered cubic lattice.

6. An additive manufactured object as a stack that includes a first metal layer made of a first metallic material and a second metal layer including second dot beads made of a second metallic material, the additive manufactured object comprising:
an intermediate layer between the first metal layer and the second metal layer, the intermediate layer including a first structural part as a structure made of the first metallic material and a second structural part as a structure made of the second metallic material, the first structural part and the second structural part engaging each other in each of unit structures, an arrangement of the unit structures arranged in the intermediate layer having translational symmetry in a plane perpendicular to a stacked direction of the first metal layer and the second metal layer, wherein
the intermediate layer includes, at a junction interface between the first structural part and the second structural part, an intermetallic compound layer including an intermetallic compound,
the first metal layer is a member of any shape that does not include a first dot bead,
the first structural part is a groove provided in the first metal layer, and
the second structural part is a bead embedded in the groove, the bead being made of the second metallic material.

7. A method of manufacturing an additive manufactured object that is a stack including a first metal layer including first dot beads made of a first metallic material and a second metal layer that includes second dot beads made of a second metallic material, the method comprising:
an intermediate layer formation of forming an intermediate layer on the first metal layer, the intermediate layer including a first structural part as a structure that includes the first dot beads and protrudes to the second metal layer while having a leading end beside the second metal layer protruding in a direction perpendicular to a stacked direction of the first metal layer and the second metal layer and a second structural part as a structure that includes the second dot beads and protrudes to the first metal layer while having a leading end beside the first metal layer protruding in a direction perpendicular to the stacked direction, the leading end of the first structural part and the leading end of the second structural part being in interlocking engagement in each of unit structures, an arrangement of the unit structures arranged in the intermediate layer having translational symmetry in a plane perpendicular to the stacked direction; and
a second metal layer formation of arranging the second dot beads on the intermediate layer in forming the second metal layer, wherein
the first metallic material and the second metallic material are a combination of materials that forms, at a junction interface between the first structural part and the second structural part, an intermetallic compound layer including an intermetallic compound, and
in the intermediate layer formation, the first dot bead of the first structural part that protrudes in a direction perpendicular to the stacked direction and the second dot bead of the second structural part that protrudes in a direction perpendicular to the stacked direction are stacked in the stacked direction and are at an identical position in a plane perpendicular to the stacked direction.

8. (canceled)
